(19) United States
(12) Patent Application Publication
(10) Pub. No.: US 2017/0001831 A1
(43) Pub. Date: Jan. 5, 2017

(54) PULLEY FOR ELEVATOR SYSTEM, ELEVATOR SYSTEM WITH PULLEY AND METHOD FOR MONITORING ELEVATOR SYSTEM

(71) Applicant: INVENTIO AG, Hergiswil NW (CH)

(72) Inventor: Yongqi Cui, Shanghai (CN)

(21) Appl. No.: 15/038,789

(22) PCT Filed: Dec. 18, 2013
(86) PCT No.: PCT/CN2013/089783

§ 371 Date: May 24, 2016

(51) Int. Cl. B66B 5/00; F16H 55/36; B66B 1/24; B66B 15/04; B66B 5/04

(52) U.S. Cl. CPC B66B 5/0018; B66B 15/04; B66B 5/04; B66B 1/24; F16H 55/36; B66B 9/00

(57) ABSTRACT

A pulley for guiding a suspension traction device of an elevator has a central portion for contacting the suspension traction device. The central portion has at least one of a protrusion and a marking for detecting whether the suspension traction device is positioned correctly on the pulley. A method for monitoring the elevator system utilizes a noise detector for detecting noise generated by contact between the suspension traction device and the protrusion and an optical detector for detecting when the marking is covered by the suspension traction device.

### FIELD

The invention relates to a pulley, to an elevator system with such a pulley and to a method for monitoring such an elevator system.

### BACKGROUND

A suspension traction means or device (STM) is a rope or belt shaped means used in elevator systems for suspending and driving an elevator car. In particular, if belt shaped STM made of a plastic material is used, there is the risk that the STM may move axially related to a pulley, over which the STM is guided, and is damaged by the edge of the pulley, which is normally made of steel. The STM can also slip or jump off the pulley when the STM is not held taut enough, e.g. when the elevator car suddenly stops, or when the STM is subject to a diagonal pull due to inhomogeneous loading of the elevator car.

To avoid the STM from slipping or jumping off a pulley, in the prior art a cover shield arranged around the pulley is used to physically prevent the STM from moving away from the pulley. A cover shield is insofar disadvantageous as it may be damaged by a wrongly positioned STM and may therefore damage the STM itself. In any case, once damaged, the means cannot effectively prevent the STM from moving away from the pulley. An example of such a cover shield is disclosed in EP 1 626 026 A2.

Another approach is to monitor the pulley and the STM with sensors located adjacent to the pulley in order to detect a misalignment of the STM. Disadvantage of this method is that every pulley must feature sensors, which in turn must be connected to a monitoring device, making therefore such an arrangement complicated, susceptible and cost-intensive.

It is therefore the aim of the present invention to provide a pulley and an elevator system with at least such a pulley and a method for monitoring such an elevator system which solves the problems of known pulleys, systems and methods and in particular which can reliably be used to monitor and early detect a misalignment of the STM before a STM is damaged or slips or jumps off a pulley.

### SUMMARY

This problem is solved with a pulley, which is suitable for guiding a suspension traction means (STM) of an elevator system, features a central portion with at least one marking for detecting if the STM is positioned correctly on the pulley. A correctly positioned STM on the pulley is as well guided correctly or aligned correctly on the pulley. Therefore, when the STM changes its alignment from correctly aligned on the pulley to incorrectly aligned on the pulley, this change of alignment can be detected by a continuous monitoring of the marking itself or a continuous monitoring of an interaction between the STM and the marking.

This marking can be exemplarily formed as a mechanical protrusion or an optical mark or a magnetic mark or the like. Exemplarily the sound can be detected, when the STM continuously touches such a protrusion. With the STM in a correctly aligned state, the interaction between the STM and the protrusion results in a certain acoustic pattern during rotation of the pulley, regardless whether the STM continuously touches the protrusion or not. A change of alignment of the STM from a correctly aligned state to an incorrectly aligned state or vice versa will result in a different acoustic pattern.

Additionally or alternatively to the monitoring of the protrusion an optical sensor, prefer-ably a camera or the like, continuously monitors a continuous appearance of an optical mark from a preferably stationary point of view. That optical mark can be a section, having for instance a different reflection or color character, compared to the surrounding of that optical mark. The optical mark can as well mechanically protrude from the surface of the central portion. From the stationary point of view the optical mark appears continuously during operation of the elevator system due to the rotation of the pulley. When the STM is correctly aligned and hence, the optical pattern based on a continuous appearing of the optical mark is continuously detectable by the optical sensor, a later change of the detected optical pattern, such as optical frequency changes, means that the STM has changed its position on the pulley and is therefore not anymore correctly aligned. Different optical patterns are based on the fact, whether the optical is at least partly or not covered by the STM. The optical sensor is arranged in a manner within the elevator system, that the optical sensor is able to detect the optical pattern.

Preferably, the central portion has an engagement surface for engaging with the suspension traction means when the suspension traction means is guided correctly and the central portion has a part adjacent to the engagement surface, whereby the part adjacent to the engagement surface has the at least one marking. The STM will only contact or touch respectively that part adjacent to the engagement surface when the STM is misaligned on the pulley. Due to fact, that the marking is part of the part adjacent to the engagement surface the interaction between the STM and the marking has a significant detectable change when the STM changes its position from being correctly aligned to being incorrectly aligned. If for instance an optical mark is part of the adjacent part, the optical mark can be continuously detected during operation with a correctly aligned STM. Failure to detect the continuously appearing optical mark during rotation of the pulley either means that the STM is not anymore aligned correctly or the monitoring detector fails to operate properly. It is advantageous that either possibility can be treated as a failure of the elevator system. If for instance the protrusion is part of the part adjacent to the engagement surface, the STM will not be worn out when the STM is aligned correctly on the pulley. Alternatively the marking can as well be part of the engaging surface.

Preferably, the central portion contains at least one end wall, whereby the part adjacent to the engagement surface has a first diameter and the end wall has a second diameter larger than the first diameter, whereby an inner side of the end wall has the least one marking. The end walls do not necessarily need to be formed as closed surfaces. End walls formed by one or more protruding segments are conceivable.

The diameter of both end walls does not need to be equal. The central portion may further feature circumferential and/or axial grooves or indentations as well as surface structuring to facilitate and improve alignment and friction of the STM. An inner side of the end wall, that means the side of the end wall facing the STM when a STM is guided over the pulley, has the specified at least one marking.

The at least one protrusion is preferably made of the same material as the pulley and is preferably formed integrally with the pulley. The at least one protrusion may also be a separated part, which is attached to the pulley by known means.

The at least one protrusion is shaped to produce a characteristic noise when the STM is driven over the pulley and the at least one protrusion is contacting the STM. The shape of the at least one protrusion is preferably substantially hemispherical. Other shapes such as substantially cylindrical are also possible.

As an alternative, the at least one protrusion may be biased in a resting position by elastic means such as a spring in order to move relatively to the end wall of the pulley when it is contacted by the STM and produce noise only after the at least one protrusion is pushed back towards its resting position by the elastic means.

When the STM is misaligned and/or driven over the pulley, the at least one protrusion will periodically contact the edge of the STM and produce a characteristic noise with a characteristic repeating frequency. If a characteristic noise develops, it is a sign that the STM is not correctly driven over the pulley and an inspection or stopping the elevator system is necessary.

In a preferred embodiment of the present invention both parts adjacent to the engagement surface, preferably the inner side of both end walls, of the pulley has at least one marking in order to allow the detection of misalignment of the STM on both sides of the STM. The at least one marking of one end wall may be located facing the at least one marking of the opposite end wall. This is however not mandatory as shown hereinafter.

In a preferred embodiment of the present invention, the pulley has a plurality of markings arranged circularly, that means in a circular pattern, which may be arranged on one or both parts adjacent to the engagement surface, preferably on one or both end walls of the pulley. The markings are preferably equally spaced apart from each other. In this way it is possible to develop the characteristic for detection more than once per turn of the pulley, whereby a characteristic frequency and/or a characteristic repeating acoustic pattern or optical pattern is dependent, besides the rotational speed of the pulley, on the spacing between two adjacent markings.

In another preferred embodiment of the present invention, the at least one protrusion is shaped to produce a first characteristic noise when the pulley rotates in one direction, while a second characteristic noise different from the first characteristic noise or no noise may be produced when the pulley rotates in the opposite direction.

The elevator system according to the present invention features a STM and at least one pulley as described above.

In a preferred embodiment, the elevator system has a plurality of pulleys, whereby every pulley has a different number and/or arrangement of protrusions. It is therefore possible to identify the pulley with a misaligned STM based on the characteristic noise and the characteristic frequency and/or the characteristic repeating acoustic pattern.

A preferred embodiment of the elevator system according to the present invention features a speed sensor for measuring the speed of the STM. The sensor may measure the speed of the STM in a direct or in an indirect way, e.g. by measuring the rotational speed of a pulley of known diameter and taking into consideration other factors such as the thickness of the STM, stretching and shortening of the STM when the system is accelerated or decelerated, etc. Knowledge of the speed of the STM is helpful for determining the characteristic frequency and/or the characteristic repeating acoustic pattern or optical pattern of the rotating pulley, in particular when a plurality of pulleys with different dimensions is present in the elevator system. Optical pattern can as well be differences in the rotation frequency of the pulley and/or optical pattern based on the speed or speed difference of the belt.

In another preferred embodiment, the number and/or arrangement of the protrusion of one end wall of a pulley is different from the number and/or arrangement of the other end wall of the pulley. It is therefore possible to determine which end wall of the pulley is touched by the misaligned STM.

The elevator system according to the present invention comprises in a preferred embodiment a monitoring device with at least one detector according to the configuration of the pulley for monitoring if the STM is guided correctly over the pulley. Therefore the detector could exemplarily be a detector for detecting the noise being made when the at least one protrusion touches the STM or an optical detector for detecting the at least one optical mark on the pulley. It is therefore possible to automatically monitor the noise produced by a misaligned STM in an elevator system according to the present invention as shown hereinafter. The noise detector must be able to detect the characteristic noise. This may occur by analyzing the waveform and/or the spectra and/or the dominant frequency and/or the power and/or the distortion and/or the harmonics and/or the bandwidth and other spectral components such attack, decay sustain and release of the detected noise. The noise detector can therefore be a microphone, a vibration sensor or an ultrasonic sensor.

The monitoring device may further include a spectrum analyzer with a Fourier transform device, a filtering device, in particular a high-, low- or band-pass filter for filtering the detected noise and may also include a noise reduction device for reducing background and signal noise.

The noise detector can be located stationary in the hoistway or movably arranged on a moving part of the elevator system, e.g. an elevator car, a counterweight, etc.

The at least one noise or optical sensor is located in a preferred embodiment of the present invention near a pulley to be monitored. Depending on the system, a plurality of pulleys may be monitored by different noise detectors arranged in the hoistway. A noise detector can also be used for monitoring a group of pulleys located in a section of the hoistway, e.g. under an elevator car.

According to the method for monitoring the elevator system of the present invention, the noise in the hoistway is monitored using the at least one noise detector, and the signal from the at least one noise detector is fed to the monitoring device, where it is processed.

The monitoring device then determines if the detected noise is a characteristic noise of a STM not positioned correctly over the at least one pulley and thus contacting the at least one protrusion. Monitoring may be done here by determining if the detected noise differs from a noise related to a normal operating mode of the elevator system. The noise related to a normal operating mode may be known by the monitoring device in advance (pre-loaded) or may be determined at regular intervals in order to take into consideration other factors such as a background noise which may vary during operation of the elevator system.

Preferably, determining if the detected acoustic or optical pattern is a characteristic pattern of a STM not positioned correctly over the at least one pulley and thus contacting or covering respectively the at least one marking is done by comparing directly the detected pattern with a characteristic pattern or data related to the characteristic pattern stored in the monitoring device.

It is also possible to process and analyze the noise detected by the at least one noise detector and determine, in addition to the parameters cited above, typical features of the detected noise, e.g. a characteristic frequency of the detected noise or a repeating pattern of the detected noise, and then compare it with data related to the at least one pulley present in the elevator system, i.e. data related to the dimensions of the at least one pulley such as the diameter of the circumference along which the protrusions are arranged, data related to the dimensions of the STM like width and thickness, the number and/or arrangement of the protrusions in order to determine if the detected noise is a characteristic noise produced by the at least one pulley with a misaligned STM.

If a characteristic noise is recognized, the monitoring device will then trigger a reaction related to the recognized characteristic noise, such as stopping the elevator system at the closest next floor, send a communication to a service center and/or an alarm to a maintenance team etc. Accordingly an optical pattern of the rotating pulley can be analyzed and/or processed.

In another preferred embodiment of the present invention, the rotational speed of the at least one pulley is taken into consideration when determining whether the detected pattern is a characteristic pattern or not. Since an elevator system is normally not operated continuously, the at least one pulley rotates with a changing rotational speed. A characteristic frequency and/or a characteristic repeating acoustic pattern or optical pattern may therefore change depending on the rotational speed of the at least one pulley, thus making use of the rotational speed of the at least one pulley a useful tool for predicting a characteristic frequency and/or characteristic repeating pattern. Detection of the rotational speed of the at least one pulley may occur directly, e.g. by means of at least one speed sensor, or indirectly, e.g. by measuring the speed of the STM or the rotational speed of a driving motor etc.

It is further possible, if a potential characteristic pattern is detected, that the monitoring device triggers a change in the rotational speed of the pulley by reducing or increasing the rotational speed of a driving motor and then monitors if the potential characteristic pattern changes its characteristic frequency and/or characteristic repeating pattern accordingly.

The position of the at least one noise detector is also taken into consideration in a preferred embodiment of the present invention. In particular if a noise detector is only configured to monitor and detect the noise produced by a specific pulley or a group of pulleys, e.g. as a directional sensor or a sensor with a sensibility only within a given distance from the sensor itself, only the characteristic noise which may be produced by the monitored pulley/s will be taken into consideration when determining if the detected noise is a characteristic noise.

The invention further relates to the use of a ring-shaped element for retrofitting existing pulleys of an elevator system, whereby the ring-shaped element is designed to form at least partially an end wall of the pulley and has at least one protrusion. All the embodiments of the pulley cited above apply also to a ring-shaped element with at least one protrusion.

### DESCRIPTION OF THE DRAWINGS

Other advantages of the present invention will become clearer from the following description of preferred embodiments. The drawings show in:

FIG. 1 a perspective view of a first embodiment of a pulley according to the present invention;

FIG. 2 a perspective view of a second embodiment of a pulley;

FIG. 3 a perspective view of a third embodiment of a pulley;

FIG. 4 a side view of possible shapes of a protrusion;

FIG. 5 a schematic view of an elevator system;

FIG. 6 a perspective view of a ring-shaped element; and

FIG. 7 a view of a pulley with markings according to the invention.

### DETAILED DESCRIPTION

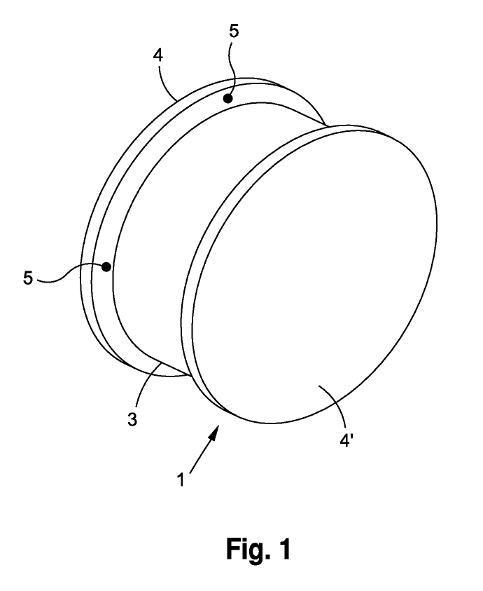

In the FIGS. 1, 2 and 3, three different pulleys 1, 1′ and 1″ are respectively shown. The pulleys 1, 1′ and 1″ share a common structure with a central portion 3. The central portion 3 contains two end walls 4 and 4′. The pulleys 1, 1′ and 1″ are preferably made of a plastic material.

Every pulley 1, 1′ and 1″ has a plurality of markings formed as protrusions 5 arranged on the inner side of the end walls 4 and 4′, whereby for perspective reasons, only the protrusions of the end wall 4 can be seen. The protrusions are made of the same material of the pulley 1, 1′ and 1″ respectively, formed integrally with the end wall 4 and 4′ and have the same substantially hemispherical shape and dimension but are arranged with a different pattern.

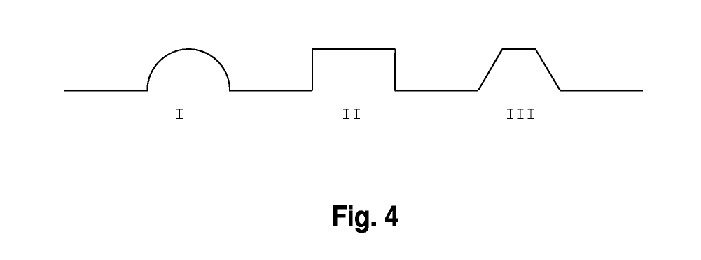

In FIG. 4, a side view of a substantially hemispherically shaped protrusion I is schematically shown near a substantially cylindrically shaped protrusion II and a substantially conically truncated shaped protrusion III. All protrusions 5 on one pulley may have one of the shapes shown in FIG. 4 or the protrusions of one pulley may have more than one of the shapes shown in FIG. 4.

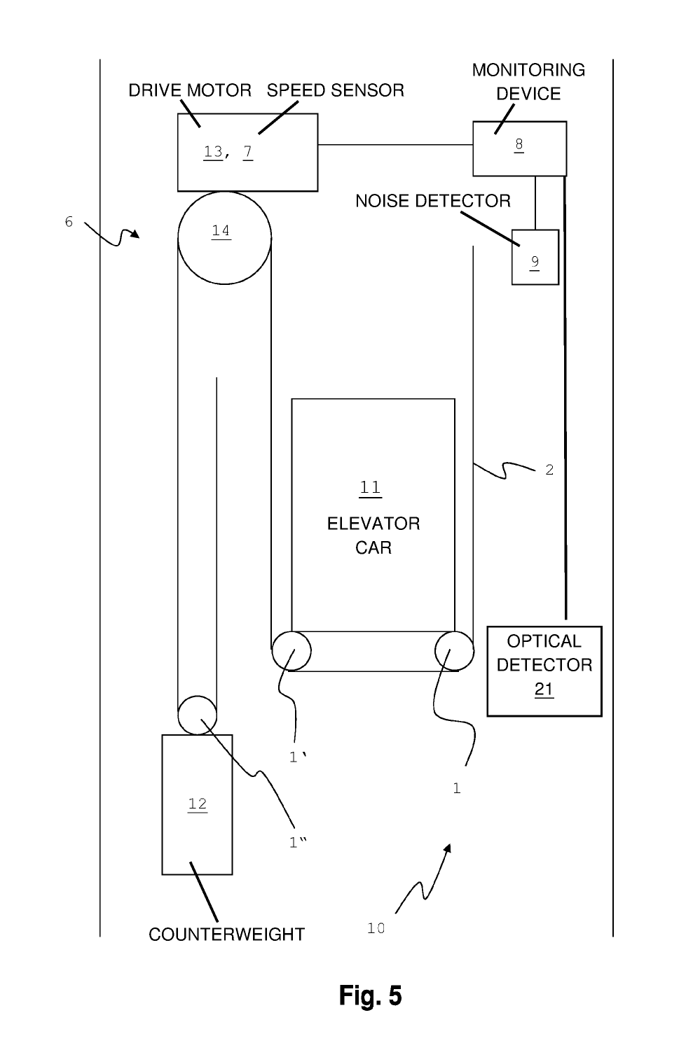

As an alternative, the protrusions may be separate components of the same or a different material of the pulley 1, 1′ or 1″ that are subsequently attached to, screwed on, etc. the inner side of the end wall 4 or 4′. This is particularly advantageous if an existing elevator system 6 as shown schematically in FIG. 5 is to be upgraded and fitted with a monitoring system according to the present invention.

It is also possible to fit pulleys each with different shaped protrusions 5 in order to generate a different characteristic noise for every pulley.

The four protrusions 5 of the pulley 1 of FIG. 1 are arranged 90° offset circularly on the inner side of the end walls 4 and 4′, whereby every protrusion 5 of the end wall 4 faces a corresponding protrusion of the opposed end wall 4′.

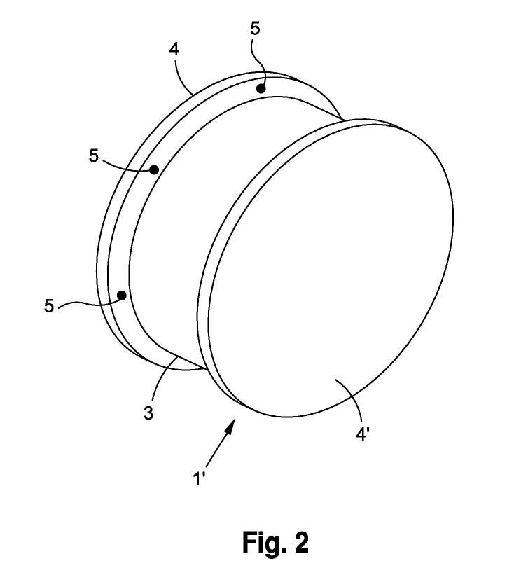

The six protrusions 5 of the pulley 1′ of FIG. 2 are arranged 60° offset circularly on the inner side of the end walls 4 and 4′, whereby every protrusion 5 of the end wall 4 faces a corresponding protrusion of the opposed end wall 4′.

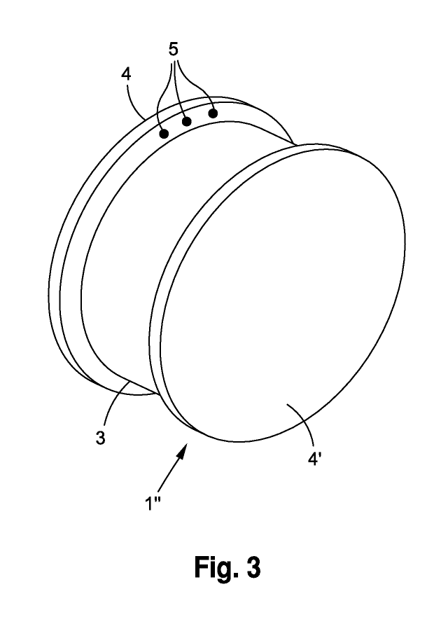

The six protrusions 5 of the pulley 1″ of FIG. 3 are not arranged equally spaced apart from each other but in two three-protrusion clusters with each protrusion 5 of the one cluster being point symmetric with a correspondent protrusion of the other cluster. Every protrusion 5 of the end wall 4 faces a corresponding protrusion of the opposed end wall 4′. In this case, if the STM is misaligned, the protrusions of the pulley 1″ will produce a noise with a characteristic pattern of three consecutive noise peaks followed by a pause repeated twice per turn of the pulley 1″.

Therefore, by arranging different pulleys 1, 1′ and 1″, i. e. pulleys with a different number and/or arrangement of protrusions 5, it is not only possible to detect misalignment of the STM but to also identify the concerned pulley 1, 1′ or 1″ on the basis of the noise produced by the unique arrangement and/or number of protrusions 5. This can save time when inspecting the concerned elevator system, in particular when a plurality of pulleys 1, 1′ and 1″ is present and particularly when a pulley is located such as being difficult or dangerous to access, thus reducing also risks for a technician inspecting the elevator system.

Accordingly, an elevator system 6 is shown schematically in the FIG. 5. The elevator system includes a support frame located within a hoistway 10 for supporting and mounting components of the elevator system 6, which, for the sake of convenience, is not shown in the FIG. 5. An elevator car 11 is also arranged within the hoistway 10.

The elevator system further comprises a counterweight 12 and a drive motor 13 with a driving sheave 14, which may also feature protrusions according to the present invention, and a speed sensor 7 for the measuring the speed of the STM 2.

The pulleys 1 and 1′ are located under the elevator car 11 and the pulley 1″ is connected to the counterweight 12. A STM 2 is attached at both its ends to the frame located in the hoistway 10 and is guided over the pulleys 1 and 1′ under the elevator car 11, over the driving sheave 14 and the pulley 1″ of the counterweight 12.

A noise detector 9 is installed within the hoistway 10 and is connected to a monitoring device 8. The monitoring device is further connected to the speed sensor 7. Connection may occur wired, in particular by means of a BUS or cables, or wireless.

The monitoring device 8 is therefore able to determine rotational speed of every pulley 1, 1′ and 1″ based on the speed of the STM 2 and data related to the pulleys 1, 1′ and 1″ respectively, in particular the diameter of every pulley 1, 1′ or 1″. The noise detector 9 is continuously feeding the detected noise to the monitoring device 8, where it is analyzed. The monitoring device 8 then determines if the detected noise corresponds to a characteristic noise produced by a STM 2 not correctly positioned over one of the pulleys 1, 1′ or 1″. In particular, the expected frequency and/or repeating pattern of the detected noise for every pulley 1, 1′ and 1″ is compared to the detected noise.

If the monitoring device 8 then recognizes that the detected noise is a characteristic noise of a STM 2 not correctly positioned over one of the pulleys 1, 1′ or 1″, it would then trigger a reaction related to the characteristic noise detected, e.g. stop the elevator system at the closest next floor and/or send an alarm to a maintenance team, etc.

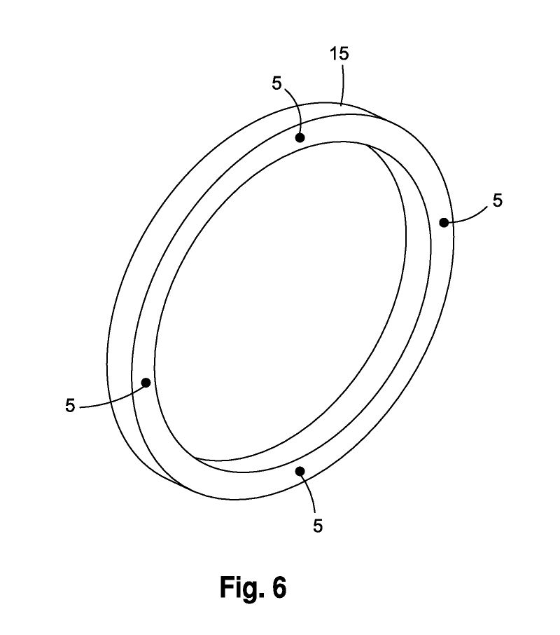

In FIG. 6, a ring-shaped element 15 with four protrusions 5 is schematically shown. The arrangement of the protrusions 5 is the same as for the pulley 1 of the FIG. 1. Such a ring-shaped element 15 may be used for retrofitting an existing elevator system without the necessity of replacing the existing pulleys. The ring-shaped element 15 is fitted on the side of the STM and is attached to the central part or the end wall of a pulley, thus forming at least partially an end wall of the pulley with at least one protrusion as shown above.

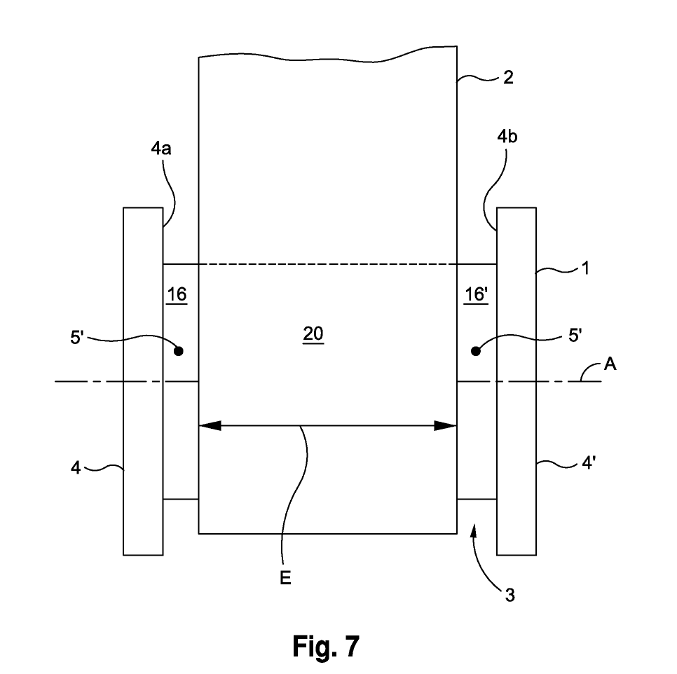

FIG. 7 shows a pulley 1 with an STM 2 correctly guided over the pulley 1. Such a pulley 1 can be part of an elevator system mentioned before. The pulley 1 is rotatably mounted on an axis A. The pulley 1 contains a central portion 3, possibly touching the STM 2. The central portion 3 contains an engagement surface 20 and may contain at least one part 16, 16′ adjacent to the engagement surface 20. The central portion 3 may contain at least one end wall 4, 4′. When correctly aligned on the pulley 1 the STM 2 only touches the engagement surface 20 having a width E which corresponds to the width of the STM 2. A first part 16 adjacent to the engagement surface 20 is arranged on one side of the pulley 1. A further second part 16′ adjacent to the engagement surface 20 is arranged on the opposite side of the pulley 1. Both of these parts 16, 16′ may only be covered at least partially by the STM 2 if the STM 2 is not correctly aligned on the pulley 1. The at least one end wall 4, 4′ has an inner side 4a, 4b facing towards the STM 2. The inner side 4a, 4b of the wall 4, 4′ and/or the at least one part 16, 16′ adjacent to the end wall 4, 4′ and/or the engagement surface 20 has at least one marking, preferably being a protrusion and/or an optical mark 5′. Such an optical mark 5′ is detectable by an optical detector 21 shown in FIG. 5 connected to the monitoring device 8.

In accordance with the provisions of the patent statutes, the present invention has been described in what is considered to represent its preferred embodiment.

However, it should be noted that the invention can be practiced otherwise than as specifically illustrated and described without departing from its spirit or scope.

1-16. (canceled)

17. A pulley for guiding a suspension traction means of an elevator, the pulley comprising:
a central portion for engaging the suspension traction means and having at least one marking thereon for detecting whether the suspension traction means is positioned correctly on the pulley.

18. The pulley according to claim 17 whereby the at least one marking is a protrusion or an optical mark.

19. The pulley according to claim 17 wherein the central portion has an engagement surface for engaging with the suspension traction means when the suspension traction means is guided correctly and the central portion has a part adjacent to the engagement surface, whereby the part adjacent to the engagement surface has the at least one marking thereon.

20. The pulley according to claim 19 wherein the central portion has at least one end wall, whereby the part adjacent to the engagement surface has a first diameter and the at least one end wall has a second diameter larger than the first diameter, whereby an inner side of the at least one end wall has the least one marking thereon.

21. The pulley according to claim 20 wherein the at least one marking is a protrusion from the at least one end wall and the protrusion is located facing another protrusion from another end wall of the central portion.

22. The pulley according to claim 17 wherein the central portion has a plurality of markings thereon arranged circularly about an axis of the pulley.

23. The pulley according to claim 22 wherein the markings are equally spaced apart from each other.

24. An elevator system comprising:
a suspension traction means; and
a pulley over which the suspension traction means is guided, the pulley having a central portion for engaging the suspension traction means and having at least one marking thereon for detecting whether the suspension traction means is positioned correctly on the pulley.

25. The elevator system according to claim 24 including a plurality of the pulley, whereby each of the pulleys has one of a different number and difference arrangement of markings thereon.

26. The elevator system according claim 24 including a speed sensor for directly or indirectly measuring a speed of the suspension traction means.

27. The elevator system according to claim 24 including a monitoring device connected to at least one noise detector for monitoring noise in a hoistway of the elevator system.

28. The elevator system according to claim 27 wherein the noise detector is located near the pulley.

29. A method for monitoring an elevator system having a suspension traction means guided over a pulley including the following steps:
monitoring a marking on a central portion of the pulley with at least one detector;
feeding a pattern of the monitored marking to a monitoring device;
determining with the monitoring device whether the pattern is a characteristic pattern of the suspension traction means not being positioned correctly over the pulley and contacting the marking on the pulley; and
triggering a reaction in the elevator system in response to determining that the pattern is the characteristic pattern.

30. The method according to claim 29 wherein the at least one detector is a noise detector and the pattern is detected noise, and including determining whether the detected noise is a characteristic noise by taking into consideration at least one of a characteristic frequency of the detected noise and a repeating pattern of the detected noise.

31. The method according to claim 30 wherein when determining whether the detected noise is the characteristic noise, a rotational speed of the pulley is taken into consideration.

32. The method according to claim 30 wherein when determining whether the detected noise is the characteristic noise, a position of the noise detector is taken into consideration.
